(19) United States
(12) Patent Application Publication
(10) Pub. No.: US 2012/0308156 A1
(43) Pub. Date: Dec. 6, 2012

(54) IMAGE PROCESSING APPARATUS, IMAGE PROCESSING METHOD, AND PROGRAM

(75) Inventor: Erika Yamazaki, Kanagawa (JP)

(73) Assignee: Sony Corporation, Tokyo (JP)

(21) Appl. No.: 13/462,951

(22) Filed: May 3, 2012

(30) Foreign Application Priority Data
May 31, 2011 (JP) 2011-121843

(51) Int. Cl. G06K 9/36

(52) U.S. Cl. 382/284

(57) ABSTRACT

There is provided an image processing apparatus comprising: a combining processing unit carrying out an image effect process and a combining process for image data of a plurality of images; and a control unit determining whether the image data of the plurality of images is image data produced by image pickup of a backlit scene and operable, if the image data was produced by image pickup of a backlit scene, to cause the combining processing unit to carry out the image effect process that converts the image data relating to the combining process to a non-photorealistic image content.

### BACKGROUND

The present disclosure relates to an image processing apparatus, an image processing method, and a program that realizes such image processing method, and in particular to an image processing technique that enables various effects to be applied to an image.

HDR (High Dynamic Range) compression processes that compress and optimize the range of tones in an image with a wide dynamic range have been conceived in the past (see for example Japanese Laid-Open Patent Publication Nos. 2008-104010 (US2008/0187235) and 2008-104009).

As one example, an image with a wide dynamic range is produced from a plurality of images with different exposures, such image is then resolved into low-frequency components and high-frequency components (detail components) using a smoothing filter, and the range of tones for the low-frequency components is compressed. After this, detail components are emphasized by an extent in keeping with the compression and finally both components after processing are combined. By doing so, the entire tonal range is compressed while minimizing the loss in detail components, thereby obtaining an image with a normal range but with improved image quality. A method that produces an image of a normal range from a plurality of images without combining an image with a high dynamic range has also been disclosed.

Japanese Laid-Open Patent Publication No. 2000-92378 (U.S. Pat. No. 7,098,946) discloses an image pickup apparatus with an image pickup mode that is capable of automatically correcting for backlighting when a subject with a large difference in luminance is present.

### SUMMARY

However, in recent years, users now want to enjoy a greater variety of images and there is demand for image effects aside from simply compressing the tonal range. For this reason, the present disclosure aims to provide an image processing method that obtains non-photorealistic image data according to the scene being photographed.

An image processing apparatus according to an embodiment of the present disclosure includes a combining processing unit carrying out an image effect process and a combining process for image data of a plurality of images, and a control unit determining whether the image data of the plurality of images is image data produced by image pickup of a backlit scene and operable, if the image data was produced by image pickup of a backlit scene, to cause the combining processing unit to carry out the image effect process that converts the image data relating to the combining process to a non-photorealistic image content.

An image processing method according to an embodiment of the present disclosure includes determining whether image data of a plurality of images to be processed is image data produced by image pickup of a backlit scene, carrying out a combining process for the image data of the plurality of images, and carrying out, if the image data was produced by image pickup of a backlit scene, an image effect process that converts the image data relating to the combining process to a non-photorealistic image content.

A program according to an embodiment of the present disclosure is a program causing a computational processing apparatus to carry out processing including determining whether image data of a plurality of images to be processed is image data produced by image pickup of a backlit scene, having a combining process for the image data of the plurality of images carried out, and carrying out, if the image data was produced by image pickup of a backlit scene, an image effect process that converts the image data relating to the combining process to a non-photorealistic image content.

According to the embodiments of the present disclosure described above, by carrying out, as image processing, a combining process on the image data of a plurality of images, it is possible to obtain image data of an HDR compressed image or the like. However, if the image data of the plurality of images is image data produced by image pickup of a backlit scene, an image effect process that produces a non-photorealistic image, such as a painterly image, is additionally carried out. By doing so, it is possible to obtain special and unusual images by carrying out image pickup of a backlit scene.

According to the embodiments of the present disclosure described above, it is possible to obtain images that have been subjected to a non-photorealistic image effect process from images picked up for a backlit scene. Accordingly, the user can enjoy non-photorealistic images by merely photographing a backlit scene or providing images picked up for a backlit scene.

### BRIEF DESCRIPTION OF THE DRAWINGS

FIG. 1 is a block diagram of an image pickup apparatus according to an embodiment of the present disclosure;

FIGS. 2A and 2B are diagrams useful in explaining a painterly image according to the present embodiment;

FIG. 3 is a block diagram of a combining processing unit according to the present embodiment;

FIG. 4 is a block diagram of a detail generating unit according to the present embodiment;

FIG. 5 is a flowchart of Processing Example I for the present embodiment;

FIGS. 6A and 6B are flowcharts showing the flow of image processing in the present embodiment;

FIG. 7 is a flowchart of Processing Example II for the present embodiment;

FIG. 8 is a flowchart of Processing Example III for the present embodiment;

FIG. 9 is a flowchart of Processing Example IV for the present embodiment;

FIG. 10 is a block diagram of another example configuration of a combining processing unit according to the present embodiment;

FIG. 11 is a block diagram of a personal computer according to the present embodiment;

FIG. 12 is a flowchart of Processing Example V applied to a personal computer according to the present embodiment;

FIG. 13 is a flowchart of Processing Example VI applied to a personal computer according to the present embodiment; and

FIG. 14 is a flowchart of Processing Example VII applied to a personal computer according to the present embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The embodiments of the present disclosure are described in the order indicated below.

### 1. Configuration of Image Pickup Apparatus

### 2. Configuration of Combining Processing Unit

### 3. Processing Example I

### 4. Processing Example II

### 5. Processing Example III

### 6. Processing Example IV

### 7. Alternative Example Configuration of Combining Processing Unit

### 8. Application to Personal Computer (Processing Examples V, VI, VII)

### 9. Program

### 10. Modifications

### 1. Configuration of Image Pickup Apparatus

First, an embodiment where an image processing apparatus according to the present disclosure is incorporated in an image pickup apparatus will be described. Note that the image processing apparatus according to the present disclosure is realized by a combining processing unit 16 and a control unit 20 described below.

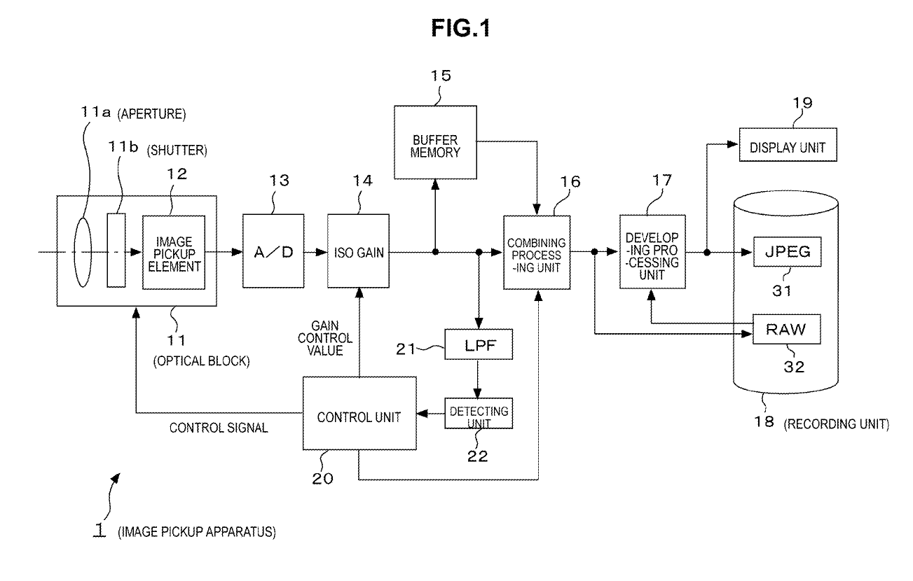

FIG. 1 is a block diagram showing an example of the principal configuration of an image pickup apparatus 1.

The image pickup apparatus 1 shown in FIG. 1 is an apparatus that picks up an image of a subject, converts the image of the subject to data, and outputs the data. The image pickup apparatus 1 includes an optical block 11, an A/D conversion unit 13, an ISO (International Organization for Standardization) gain adjusting unit 14, a buffer memory 15, the combining processing unit 16, a developing processing unit 17, a recording unit 18, a display unit 19, the control unit 20, an LPF (Low-Pass Filter) 21, and a detecting unit 22.

The optical block 11 includes a lens for focusing light from the subject on an image pickup element 12, a driving mechanism for moving the lens to carry out focusing and/or zooming (neither of which is shown), an aperture 11a, a shutter 11b, and the like. The driving mechanism inside the optical block 11 is driven in accordance with control signals from the control unit 20. The image pickup element 12 is an image pickup element such as a CCD (Charge Coupled Device) or a CMOS (Complementary Metal Oxide Semiconductor) and converts incident light from the subject to an electric signal.

The A/D conversion unit 13 converts the image signal outputted from the image pickup element 12 to digital data. The ISO gain adjusting unit 14 applies a uniform gain to the respective RGB (Red, Green, and Blue) components of the image data from the A/D conversion unit 13 in accordance with a gain control value from the control unit 20. Note that adjustment of the ISO gain may be carried out at the analog image signal stage before input into the A/D conversion unit 13.

The buffer memory 15 temporarily stores data of a plurality of images obtained by bracketed image pickup where a plurality of images are consecutively picked up with respectively different exposures. The combining processing unit 16 combines the plurality of images inside the buffer memory 15 that were obtained by bracketed image pickup into a single image. In particular, in the present embodiment, the combining processing unit 16 carries out a combining process as an an HDR compression process. The combining processing unit 16 also carries out an image effect process that obtains a non-photorealistic image (a painterly image) by carrying out a detail adjusting process on the combined image data.

The developing processing unit 17 is a block that mainly converts RAW image data outputted from the combining processing unit 16 to visible image data, or in other words, carries out a RAW developing process. The developing processing unit 17 carries out a data interpolation (demosaicing) process, various color adjustment/conversion processes (such as a white balance adjusting process, a high luminance knee compression process, a gamma correction process, an aperture correction process, and a clipping process), an image compression encoding process according to a predetermined encoding technique (here, a JPEG (Joint Photographic Experts Group) technique is used), and the like on the RAW image data.

The recording unit 18 is an apparatus for storing image data obtained by image pickup as a data file and as one example is realized by a removable flash memory, an HDD (Hard Disk Drive), or the like. Note that aside from the JPEG data 31 encoded by the developing processing unit 17, the recording unit 18 is capable of recording RAW image data 32 outputted from the combining processing unit 16 as a data file. It is also possible for the RAW image data recorded in the recording unit 18 to be read out, processed by the developing processing unit 17, and newly recorded as a JPEG data file in the recording unit 18.

The display unit 19 includes a monitor constructed for example of an LCD (Liquid Crystal Display). Based on image data in an uncompressed state processed by the developing processing unit 17, the display unit 19 generates an image signal for display on a monitor and supplies the image signal to the monitor. In a preview state before the recording of the picked up images, picked up image signals are consecutively outputted from the image pickup element 12, converted to digital, and then the digital image data is supplied via the ISO gain adjusting unit 14 and the combining processing unit 16 to the developing processing unit 17 and is subjected to a developing process (with the encoding process omitted). The display unit 19 displays the images (preview images) successively outputted from the developing processing unit 17 at this time on the monitor. The user is therefore capable of viewing the preview images and confirming the angle of field.

The control unit 20 is constructed by a microcomputer equipped with a CPU (Central Processing Unit), a ROM (Read Only Memory), and a RAM (Random Access Memory), and the like. By executing a program stored in the ROM, the CPU carries out overall control over the entire image pickup apparatus 1. As one example, in the present embodiment, the control unit 20 calculates an exposure correction value based on a detection result from the detecting unit 22 and outputs a control signal in keeping with the exposure correction value to control the aperture 11a and/or the shutter 11b and thereby realize AE (Automatic Exposure) control. When carrying out high dynamic range image pickup, the calculated exposure correction value is also supplied to the combining processing unit 16. In addition, the control unit 20 controls an image effect process for producing painterly images at the combining processing unit 16.

The LPF 21 carries out a low pass filter process as necessary on the image data outputted from the ISO gain adjusting unit 14. The detecting unit 22 is a block that carries out various signal detection based on the image data supplied from the ISO gain adjusting unit 14 via the LPF 21. In the present embodiment, as one example the detecting unit 22 divides an image into specified photometric regions and detects luminance values in each photometric region. The control unit 20 is capable of determining, from the detection information produced by the detecting unit 22, whether image data outputted from the ISO gain adjusting unit 14, that is, image data that has been picked up or image data that is a preview image before image pickup is in a backlit state.

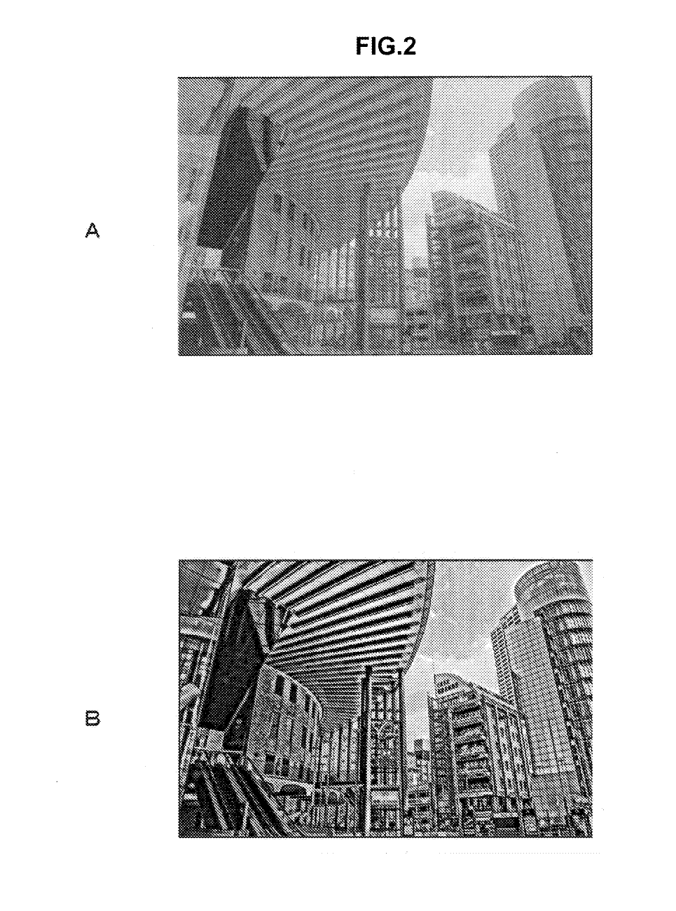

In the image pickup apparatus 1 according to the present embodiment, according to the image processing by the combining processing unit 16 and the control by the control unit 20, a combining process and an image effect process are carried out on the picked up image data. The combining process is combining according to an HDR compression process, for example, and the image effect process is a process that converts the picked-up image content to a painterly image, for example. FIG. 2B shows an example of a painterly image. FIG. 2A is an example of an image that has been picked up normally, and compared to this, FIG. 2B is a non-photorealistic image.

In the present embodiment, in particular, the control unit 20 determines whether the image data to be processed is in a backlit state and has an image effect process that obtains a painterly image carried out according to whether the image data is backlit. By doing so, an image that is automatically subjected to a painterly visual effect in keeping with the image pickup conditions is obtained. After this, it is possible to display such image data on the display unit 19 and/or to record the image data on the recording unit 18 as the JPEG data 31. Note that the encoding technique for the image data recorded by the recording unit 18 is arbitrary. The recording unit 18 may therefore record image data that has been encoded according to an encoding technique aside from JPEG.

### 2. Configuration of Combining Processing Unit

Next, the configuration and operation of the combining processing unit 16 in the image pickup apparatus 1 configured as described above will be described. As described earlier, the combining processing unit 16 carries out a combining process (HDR process) and an image effect process on the picked up image data in accordance with control by the control unit 20.

As the HDR process in the present embodiment, a plurality of images with respectively different exposure conditions are combined so as to have reduced image quality deterioration, such as blown-out highlights or blocked shadows, and thereby generate an image with a suitable tonal range. For example, for a scene where a wide luminance range is included in the angle of field, there will be deterioration in the precision of automatic exposure processing (AE processing), resulting in a high probability of the main subject in the angle of field being overexposed resulting in blown-out highlights or being underexposed resulting in a noisy image with blocked shadows. For this reason, as an image pickup method for obtaining images that are picked up with appropriate exposure conditions in this type of scene, a method called “bracketed image pickup” is known where a plurality of exposures are taken consecutively while changing the exposure conditions to obtain a plurality of image signals.

An image pickup method that uses bracketed image pickup to produce an image (HDR image) with a higher dynamic range than the output of the image pickup element is also conceivable. When generating an HDR image, a picked-up image with an increased exposure and a picked-up image with a reduced exposure are obtained by bracketed image pickup and such picked-up images are then combined to generate an HDR image. That is, by combining image components where high-luminance tones have been appropriately obtained by reducing the exposure and image components where low-luminance tones have been appropriately obtained by increasing the exposure, it is possible to incorporate tone information with a wide luminance range that could not be obtained by a single exposure into the image after combining.

In the present embodiment, HDR processing is carried out using at least two sets of image data that are picked up using bracketed image pickup and are respectively overexposed and underexposed. As a specific example, the case where three sets of image data picked up according to bracketed image pickup where the exposure conditions are respectively “overexposed”, “appropriately exposed”, and “underexposed” will now be described.

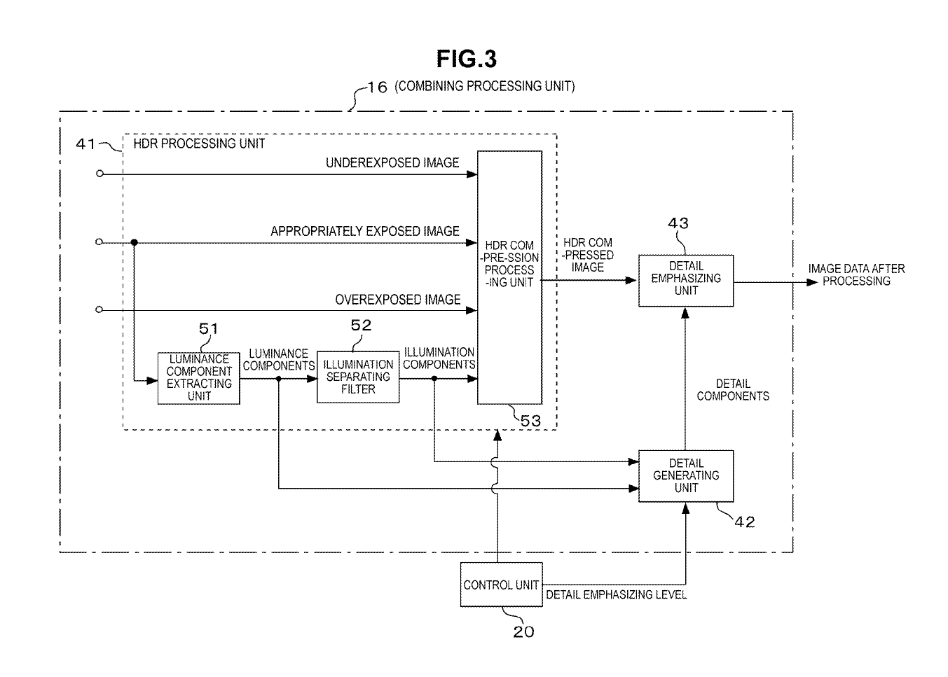

FIG. 3 is a block diagram showing an example configuration of the combining processing unit 16. The combining processing unit 16 carries out an HDR process that compresses the tonal range and also carries out a painterly process that applies a painterly visual effect. Three images (an overexposed image, an appropriately exposed image, and an underexposed image) with respectively different exposure conditions are inputted into the combining processing unit 16. These three images are obtained by carrying out bracketed image pickup according to control by the control unit 20 and are temporarily stored in the buffer memory 15.

The combining processing unit 16 includes a luminance component extracting unit 51, an illumination separating filter 52, an HDR compression processing unit 53, a detail generating unit 42 and a detail emphasizing unit 43.

Out of such configuration, the luminance component extracting unit 51, the illumination separating filter 52, and the HDR compression processing unit 53 construct an HDR processing unit 41 that carries out an HDR process to combine the three images with different exposure conditions so as to reduce image deterioration such as blown-out highlights and blocked shadows and thereby generate an image with an appropriate tonal range. The detail generating unit 42 and the detail emphasizing unit 43 also apply a painterly visual effect to the image.

As described earlier, the underexposed image generated by deliberately reducing the exposure below the appropriate level, the appropriately exposed image generated with the exposure at the appropriate level, and the overexposed image generated by deliberately increasing the exposure above the appropriate level are inputted into the combining processing unit 16. Such images are supplied to the HDR compression processing unit 53.

The appropriately exposed image is also supplied to the luminance component extracting unit 51. The luminance component extracting unit 51 extracts luminance components from the inputted appropriately exposed image and supplies the luminance components to the illumination separating filter 52 and the detail generating unit 42. Note that although the luminance component extracting unit 51 extracts the luminance components from the appropriately exposed image in this example, it would also be conceivable to use a configuration where the underexposed image or the overexposed image is supplied to the luminance component extracting unit 51 and the luminance components are extracted from the supplied image.

The illumination separating filter 52 extracts illumination components (low frequency components) from the inputted luminance components using an edge preserving smoothing filter or the like. The illumination separating filter 52 then supplies the extracted illumination components to the HDR compression processing unit 53 and the detail generating unit 42. Note that to extract the illumination components, it is desirable to use a nonlinear low-pass filter (as examples, the filter in Japanese Laid-Open Patent Publication No. 2008-104010 or a bilateral filter) that removes high frequencies so as to preserve edge components. Also, as similar low-pass filter processing, aside from a nonlinear low-pass filter, it is possible to use a statistical method (for example, a mode filter or a median filter).

The HDR compression processing unit 53 converts the illumination components supplied from the illumination separating filter 52 to combining coefficients using a specified conversion table and then uses such combining coefficients to combine the inputted underexposed image, appropriately exposed image, and overexposed image. More specifically, the HDR compression processing unit 53 adds weightings to the respective images using the combining coefficients and adds the weighted images together. By doing so, image data (HDR compressed image data) with an appropriate tonal range and with reduced image deterioration such as blown-out highlights or blocked shadows is generated from the underexposed image, the appropriately exposed image, and the overexposed image. The HDR compression processing unit 53 supplies the generated HDR compressed image data to the detail emphasizing unit 43.

The control unit 20 sets a detail emphasizing level, which is the extent to which reflectance components are to be emphasized in the HDR compressed image and is used to apply a painterly visual effect, for the combining processing unit 16. That is, the detail emphasizing level is the gain for excessively emphasizing detail components in the HDR compressed image. The control unit 20 supplies the detail emphasizing level to the detail generating unit 42.

The detail generating unit 42 uses the luminance components in the appropriately exposed image supplied from the luminance component extracting unit 51 and the illumination components for the luminance components in the appropriately exposed image supplied from the illumination separating filter 52 to extract reflectance components (detail components: high-frequency components) for the luminance components in the appropriately exposed image. As examples, the detail generating unit 42 extracts the reflectance components by subtracting the illumination components from the luminance components or dividing the luminance components by the illumination components. In addition, the detail generating unit 42 emphasizes the extracted reflectance components using the detail emphasizing level supplied from the control unit 20 to generate emphasized detail components. The detail generating unit 42 supplies the emphasized detail components to the detail emphasizing unit 43.

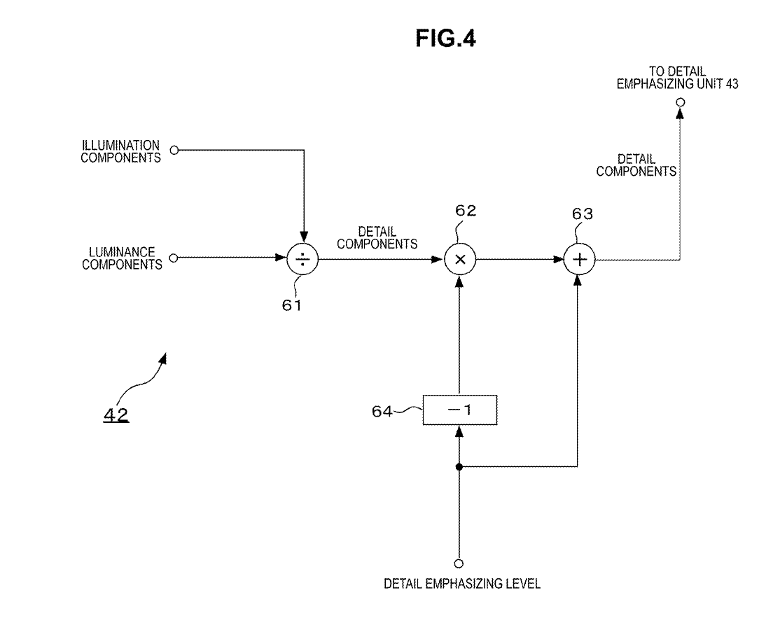

FIG. 4 shows an example configuration of the detail generating unit 42. The detail generating unit 42 includes a divider unit 61, a multiplier unit 62, an adder unit 63, and a subtractor unit 64. The divider unit 61 divides the luminance components supplied from the luminance component extracting unit 51 by the illumination components supplied from the illumination separating filter 52 to extract the detail components. The divider unit 61 supplies the extracted detail components to the multiplier unit 62. To compensate for a detail gain that is automatically applied as a standard, the subtractor unit 64 subtracts the value “1” from the detail emphasizing level supplied from the control unit 20. The subtractor unit 64 then supplies the result of subtracting “1” from the detail emphasizing level to the multiplier unit 62.

The multiplier unit 62 multiplies the detail components supplied from the divider unit 61 by the detail emphasizing level supplied from the subtractor unit 64 and supplies the multiplication result to the adder unit 63. The adder unit 63 adds the detail emphasizing level supplied from the control unit 20 to the result of multiplying the detail components by the result of subtracting “1” from the detail emphasizing level which has been supplied from the multiplier unit 62. The adder unit 63 supplies the addition result, for example, detail components that have been excessively emphasized, to the detail emphasizing unit 43.

By multiplying the detail components supplied from the detail generating unit 42, the detail emphasizing unit 43 shown in FIG. 3 excessively emphasizes the details in the HDR compressed image data supplied from the HDR compression processing unit 53 and thereby applies a painterly visual effect. By doing so, the detail emphasizing unit 43 is capable of outputting, as the image data after processing, an HDR compressed image in which details have been emphasized to produce a painterly effect. In this case, using the detail components multiplied by the detail emphasizing unit 43, it is also possible to produce an HDR compressed image that is corrected for backlighting. That is, the detail emphasizing unit 43 is also capable of outputting an HDR compressed image that has been corrected for backlighting as the image data after processing.

Here, it is possible to control whether the image effect process is a process that achieves a painterly effect or is a backlighting correction process according to the detail emphasizing level outputted from the control unit 20. Note that it is possible to produce a more pronounced painterly effect for the painterly HDR image data outputted from the detail emphasizing unit 43 by further processing such as compressing the bit length.

As described above, by merely having the detail emphasizing unit 43 excessively amplify only the reflectance components in the HDR compressed image to an extent where details appear more emphasized than in reality (i.e., by excessively emphasizing details), the image processing apparatus 1 is capable of easily combining a plurality of images with different exposure conditions to generate an image with an appropriate tonal range and with reduced image deterioration such as blown-out highlights and blocked shadows, and to also apply a painterly visual effect to the image. The value of the detail emphasizing level is arbitrary but in general by setting the detail emphasizing level higher, such as by setting the value at double, quadruple, or eight times, it is possible to increase the emphasizing of details and to apply a more pronounced painterly visual effect to the image.

When applying a more pronounced painterly visual effect to the image, the control unit 20 sets a large value (for example, a value that is sufficiently larger than 1) as the detail emphasizing level. Also, when a pronounced painterly visual effect is not desired for the image, and in particular when correcting for backlighting in the case of the present embodiment, a low value (for example, 1) is set as the detail emphasizing level. That is, by controlling the magnitude of the detail emphasizing level, the control unit 20 is capable of controlling whether the HDR compression process is carried out faithfully for the subject (to produce a backlighting corrected image for a backlit image) or whether a painterly visual effect is applied.

Note that the detail emphasizing level may be set at a value in keeping with the luminance. That is, by changing the emphasizing level according to the luminance of the illumination components, the detail emphasizing unit 43 is capable of amplifying only the required frequency band that is recognized as details. By doing so, it is possible to suppress the amplification of low frequencies that are not details and high frequencies that generally tend to include a large unnecessary noise component, and thereby suppress visible deterioration in the image. It is also possible to amplify the detail components only in a region that is part of an image or to set the detail emphasizing level in keeping with a position in the image.

### 3. Processing Example I

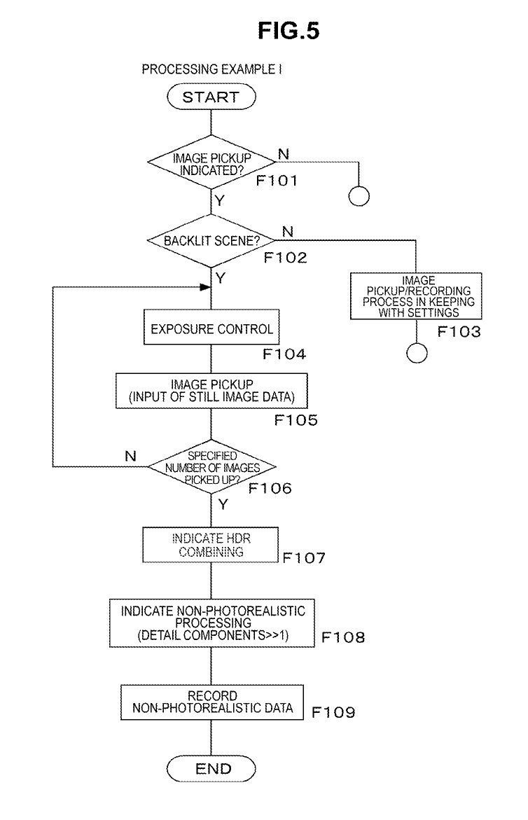

A specific example (“Processing Example I”) of the control process of the control unit 20 in the image pickup apparatus 1 equipped with the combining processing unit 16 described above will now be described. FIG. 5 shows the control process of the control unit 20.

When an image pickup instruction has been issued, the control unit 20 proceeds from step F101 to step F102. The image pickup instruction is issued according to an image pickup trigger given at certain timing, such as by a release operation by the user of the image pickup apparatus 1 or by a program that carries out automatic image pickup.

When the processing has proceeded to step SF102 according to an image pickup instruction, the control unit 20 confirms whether image pickup is presently being carried out for a backlit scene. This may be determined based on luminance values detected by the detecting unit 22 for an image (image data used for a preview image) being inputted by the image pickup element 12 at the present time. If the scene is not backlit, the processing advances to step F103 and image pickup according to various settings that are currently valid and a recording process that records a picked up image in the recording unit 18 are carried out. For example, an image pickup operation is carried out in keeping with an image pickup mode, exposure settings, correction settings, and special effect settings, in addition to user settings and settings of an automatic image pickup program.

Meanwhile, if the scene is backlit, the control unit 20 proceeds to the processing in step F104 onwards. In steps F104, F105, and F106, the control unit 20 carries out control to have image pickup carried out for data of a specified number of still images (for example, three). That is, image pickup is carried out for an underexposed image, an appropriately exposed image, and an overexposed image. First, exposure control is carried out in step F104 to set the exposure state. As the exposure control, as examples, the aperture 11a, the shutter speed (exposure length) of the image pickup element 12, and/or the gain of the ISO gain adjusting unit 14 are set. By doing so, as one example, an overexposed state is set first. After this, image pickup (i.e., the writing of picked-up image data into the buffer memory 15) is carried out in step F105.

This procedure is repeated until it is determined in step F106 that pickup of the specified number of images (for example, three) has been completed. As one example, during pickup of the second image, control to set an appropriately exposed state is carried out in step F104 and image pickup is carried out in step F105. During pickup of the third image, control to set an underexposed state is carried out in step F104 and image pickup is carried out in step F105.

For example, when image pickup has been carried out for such three images, the control unit 20 proceeds from step F106 to F107 and has an HDR combining process carried out. That is, the control unit 20 gives an instruction for the transferring of the three sets of image data (that is, the underexposed image, the appropriately exposed image, and the overexposed image) temporarily stored in the buffer memory 15 to the combining processing unit 16 and has the combining processing unit 16 carry out an HDR process. In addition, in step F108, the control unit 20 instructs the combining processing unit 16 to carry out a non-photorealistic image processing. More specifically, the control unit 20 supplies a detail emphasizing level of a value sufficiently higher than 1 for example to the detail generating unit 42 of the combining processing unit 16. By doing so, painterly image processing is carried out. Next, in step F109, the control unit 20 carries out control to have the image data produced by the painterly image processing in the combining processing unit 16 recorded in the recording unit 18.

By having the control unit 20 carry out the above processing, when for example the user carries out image pickup of a backlit scene, a painterly image is automatically picked up and is recorded as the JPEG data 31 or as the RAW data 32, for example.

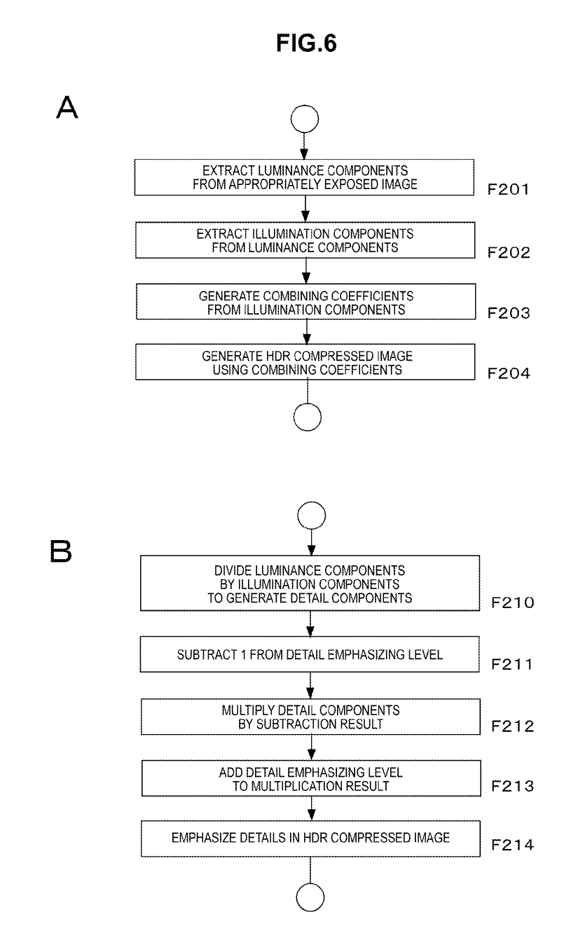

Note that the flow of image processing carried out by the combining processing unit 16 according to an instruction for an HDR process in step F107 is shown in FIG. 6A. In step F201, the luminance component extracting unit 51 extracts luminance components from the appropriately exposed image. In step F202, the illumination separating filter 52 extracts the illumination components from the luminance components extracted in step F201. In step F203, the HDR compression processing unit 53 uses a conversion table, for example, to generate combining coefficients from the luminance components extracted in step F202. In step F204, the HDR compression processing unit 53 uses the combining coefficients generated in step F203 to apply weightings to the underexposed image, the appropriately exposed image, and the underexposed image and combines the weighted images so as to reduce image deterioration such as blown-out highlights and blocked shadows, thereby generating an HDR compressed image with an appropriate tonal range.

The flow of the image processing carried out by the combining processing unit 16 according to an instruction for non-photorealistic image processing in step F108 for the control unit 20 is shown in FIG. 6B. In step F210, the divider unit 61 of the detail generating unit 42 divides the luminance components extracted in step F201 by the luminance components extracted in step F202 to extract the detail components. In step F211, the subtractor unit 64 of the detail generating unit 42 subtracts the value “1” from the detail emphasizing level set by the control unit 20. In step F212, the multiplier unit 62 of the detail generating unit 42 multiplies the detail components calculated in step F210 by the subtraction result calculated in step F211. In step F213, the adder unit 63 of the detail generating unit 42 adds the detail emphasizing level set by the control unit 20 to the multiplication result calculated in step F212. In step F214, by multiplying the addition result calculated in step F213, the detail generating unit 42 emphasizes the details of the HDR compressed image generated in step F204.

By carrying out the processing described above, HDR image data with emphasized details, that is, painterly image data, is generated. Note that although the processing has been split between FIGS. 6A and 6B for ease of explanation, such processing may be carried out consecutively inside the combining processing unit 16 as a series of processes.

According to Processing Example I described above, when image pickup is carried out for a backlit scene according to a user operation or automatic image pickup, an operation is automatically carried out to combine a plurality of images with different exposure conditions so as to reduce image quality deterioration such as blown-out highlights and blocked shadows and generate an image with an appropriate tonal range and to additionally apply a painterly visual effect to such image. By doing so, when an image is picked up for a backlit scene, the user can obtain an artistic image with a painterly effect and does not need to carry out any special setting operation to do so (such as an operation that indicates the painterly effect). Note that the painterly image data generated by the above processing may be recorded in the recording unit 18 and although not shown in FIG. 1, may be outputted via an external interface to an external device.

### 4. Processing Example II

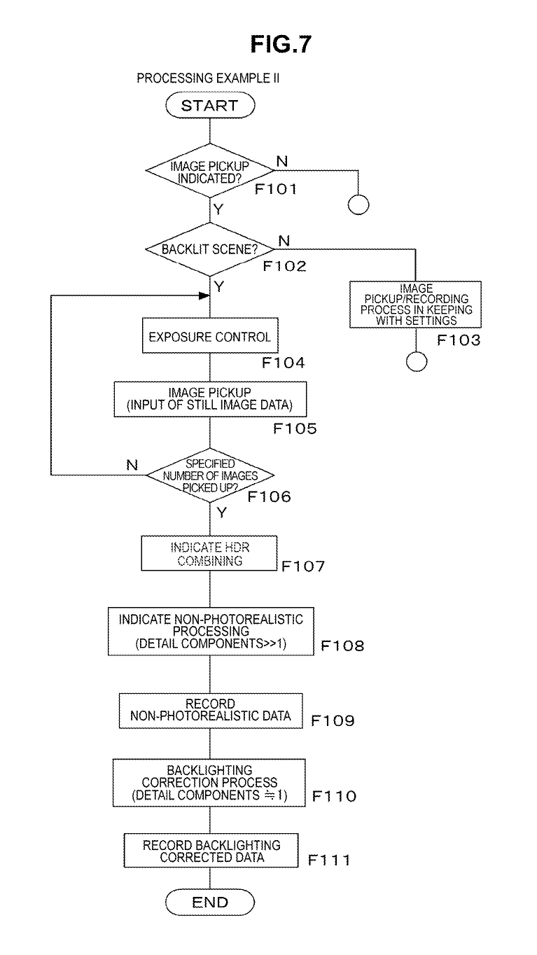

Next, Processing Example II for the control unit 20 will be described with reference to FIG. 7. In FIG. 7, processes that are the same as in FIG. 5 have been assigned the same step numbers and description thereof is omitted. That is, the processing in steps F101 to F109 is the same. In the processing in FIG. 7, after the painterly image data has been recorded in step F109, steps F110 and F111 are additionally carried out.

In step F110, the control unit 20 instructs the combining processing unit 16 to carry out a backlighting correction process. More specifically, the control unit 20 provides the detail generating unit 42 of the combining processing unit 16 with a detail emphasizing level of a low value (for example, 1). Although the processing carried out by doing so is the same as in FIG. 6B, by setting the detail emphasizing level at ≈1, a painterly image is not produced by the processing of the detail emphasizing unit 43 and instead an image that results from an HDR combining process, or in other words, an image corrected for backlighting, is obtained. After this, in step F111, the control unit 20 carries out control to have the backlighting-corrected image data outputted from the combining processing unit 16 recorded in the recording unit 18. Note that to carry out such processing, the HDR compression processing unit 53 temporarily stores the generated HDR compressed image, and when the processing is carried out in step F108 and in step F110, such image is supplied to the detail emphasizing unit 43.

According to Processing Example II, when image pickup is carried out for a backlit scene by the user or automatic image pickup, it is possible to automatically obtain both a painterly image and a backlighting-corrected image with an appropriate tonal range. Accordingly, when image pickup has been carried out for a backlit scene, the user can obtain both a backlighting-corrected image and an artistic image with a painterly effect and does not need to carry out any special setting operation to do so.

Note that the painterly image data and the backlighting-corrected image data generated by the above processing may be recorded in the recording unit 18 and although not shown in FIG. 1, may be outputted via an external interface to an external device. Also, the processing of the painterly image data in steps F108 and F109 and the processing of the backlighting-corrected image data in steps F110 and F111 may be carried out in the opposite order or may be carried out in parallel.

### 5. Processing Example III

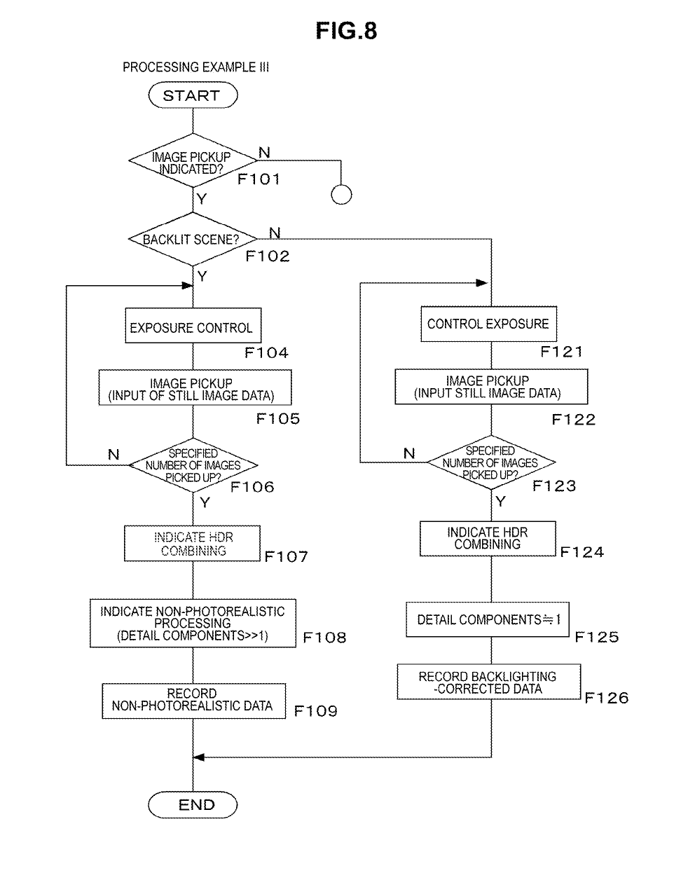

Next, Processing Example III for the control unit 20 will be described with reference to FIG. 8. In FIG. 8, processes that are the same as in FIG. 5 have been assigned the same step numbers and description thereof is omitted. That is, the processing in steps F101 to F109 is the same. The processing in FIG. 8 is an example where HDR processing is carried out even if it has been determined in step F102 that the scene is not backlit.

If it has been determined that the scene is not backlit, in steps F121, F122, and F123, the control unit 20 carries out control to have image pickup carried out for data of a specified number of still images (for example, three). The control process in this case is the same as in step F104, F105, and F106, that is, image pickup of an underexposed image, an appropriately exposed image, and an overexposed image is carried out.

When it has been determined in step F123 that pickup of the specified number of images (for example, three) has been completed, the control unit 20 proceeds to step F124 and has an HDR combining process carried out. That is, the control unit 20 gives an instruction for the transferring of the three sets of image data (that is, the underexposed image, the appropriately exposed image, and the overexposed image) temporarily stored in the buffer memory 15 to the combining processing unit 16 and has the combining processing unit 16 carry out an HDR process. The processing carried out by the HDR processing unit 41 is the same as that described with reference to FIG. 6A.

In addition, in step F125, the control unit 20 sets the detail emphasizing level at ≈1. That is, control is carried out so that an image effect process that converts the image data relating to the HDR combining process to a non-photorealistic image is not carried out. This means that the image data outputted from the detail emphasizing unit 43 is normal HDR compressed image data that has not been given any special painterly effect. After this, in step F126, the control unit 20 carries out control to have the image data outputted from the combining processing unit 16 recorded in the recording unit 18.

By having the control unit 20 carry out the processing described above, when the user, for example, carries out image pickup of a backlit scene, a painterly image is automatically picked up and recorded, for example, as the JPEG data 31 or the RAW data 32 (F104 to F109). Meanwhile when image pickup is carried out for a scene that is not backlit, high quality HDR image data with fewer blocked shadows and blown-out highlights is automatically obtained (F121 to F126). As the control by the control unit 20 related to the image effect process, it is sufficient to simply change the setting of the detail emphasizing level supplied to the detail generating unit 42 according to whether a scene is backlit. By doing so, a variety of images can be automatically provided to the user.

### 6. Processing Example IV

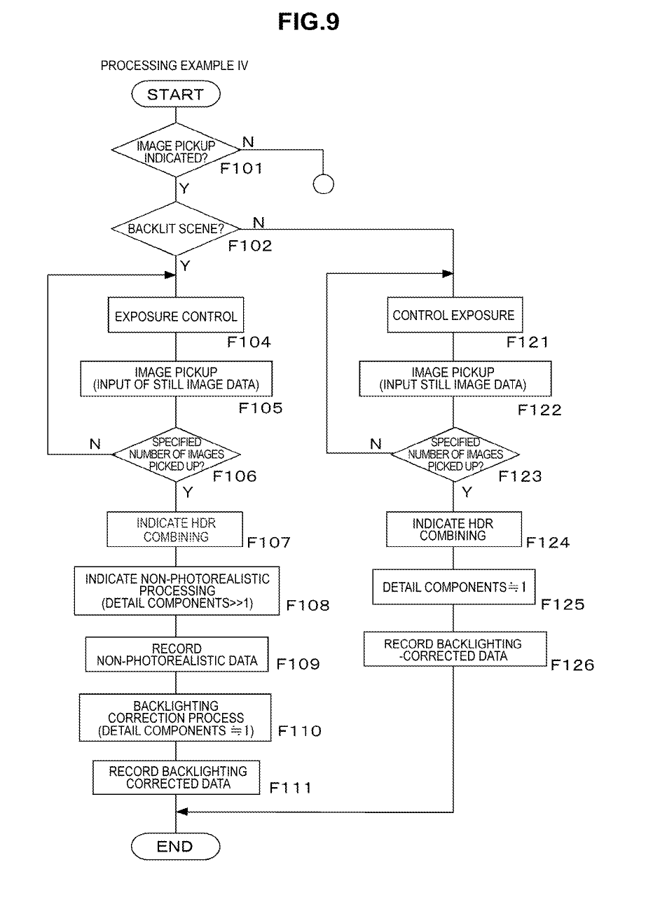

Next, Processing Example IV for the control unit 20 will be described with reference to FIG. 9. In FIG. 9, processes that are the same as in FIG. 7 or FIG. 8 have been assigned the same step numbers and description thereof is omitted. That is, the processing in steps F101 to F111 is the same as in FIG. 7 and the processing in steps F121 to F126 is the same as in FIG. 8.

That is, in the processing in FIG. 9, if it has been determined in step F102 that the scene is backlit, the processing in steps F104 to F111 is carried out and by doing so, painterly image data and backlighting-corrected image data are recorded. Meanwhile, if it has been determined in step F102 that the scene is not backlit, steps F121 to F126 are carried out and by doing so, HDR image data is recorded.

Accordingly, when image pickup has been carried out for a backlit scene, the user can obtain both a backlighting-corrected image and an artistic image with a painterly effect, but when image pickup has been carried out for a non-backlit scene, the user can obtain high-quality HDR image data. Also, the user does not need to carry out any special setting operation to do so. In this case also, as the control by the control unit 20 related to the image effect process, it is sufficient to simply change the setting of the detail emphasizing level supplied to the detail generating unit 42 according to whether the scene is backlit. By doing so, a variety of images can be automatically provided to the user.

### 7. Alternative Example Configuration of Combining Processing Unit

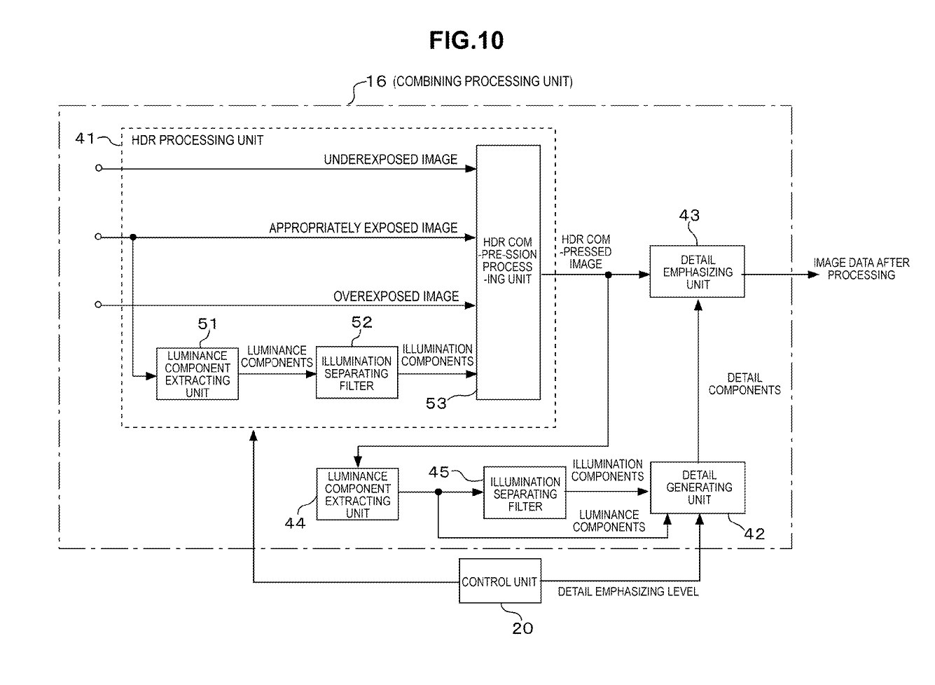

Another example configuration of the combining processing unit 16 is shown in FIG. 10. In FIG. 10, parts that are the same as in FIG. 3 have been assigned the same reference numerals and description thereof is omitted.

FIG. 10 differs to FIG. 3 in that the luminance components and illumination components for generating the detail components are obtained from an HDR compressed image. For this reason, a luminance component extracting unit 44 and an illumination separating filter 45 are provided separately to the HDR processing unit 41.

As shown in FIG. 10, the luminance component extracting unit 44 is supplied with the HDR compressed image. After this, the luminance component extracting unit 44 extracts the luminance components from the HDR compressed image and supplies the luminance components to the illumination separating filter 45 and the detail generating unit 42. The illumination separating filter 45 extracts the illumination components from the inputted luminance components using an edge preserving smoothing filter or the like. The illumination separating filter 45 then supplies the extracted illumination components to the detail generating unit 42. The processing of the detail generating unit 42 and the detail emphasizing unit 43 is the same as in the configuration shown in FIG. 3 described earlier. It is also possible to apply Processing Examples I (FIG. 5), II (FIG. 6), III (FIG. 7), and IV (FIG. 9) to the processing of the control unit 20.

With this configuration also, when image pickup is carried out for a backlit scene, it is possible to generate and record painterly image data or (or in addition to) backlighting-corrected image data.

### 8. Application to Personal Computer (Example Processes V, VI, VII)

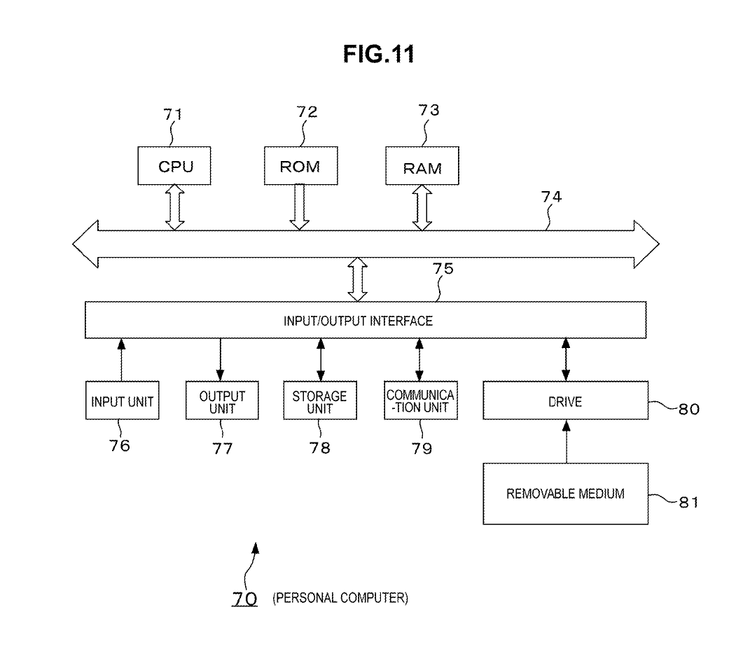

The series of processes described above can be executed by hardware and can also be executed by software. In such case, as one example, it is possible to have the image processing of the image pickup apparatus 1 described above carried out in a personal computer such as that shown in FIG. 11.

In FIG. 11, a CPU 71 of a personal computer 70 executes various processes in accordance with a program stored in a ROM 72 or a program that has been loaded from a storage unit 78 into a RAM 73. Data required for the CPU 71 to execute various processes may also be stored as appropriate in the RAM 73. The CPU 71, the ROM 72, and the RAM 73 are connected to each other via a bus 74. An input/output interface 75 is also connected to this bus 74.

The input/output interface 75 is connected to an input unit 76 composed of a keyboard, a mouse, and the like, an output unit 77 composed of a display such as a CRT (Cathode Ray Tube) or an LCD (Liquid Crystal Display) and a speaker or the like, a storage unit 78 composed of a hard disk drive or the like, and a communication unit 79 composed of a modem or the like. The communication unit 79 carries out a communication process via a network such as the Internet.

The input/output interface 75 is also connected as necessary to a drive 80 into which a removable medium 81 such as a magnetic disk, an optical disc, a magneto-optical disc, or a semiconductor memory is loaded as appropriate so that a computer program read out from the removable medium 81 can be installed as necessary into the storage unit 78.

When the series of processes described above is carried out by software, a program that constructs such software is installed from the network or a recording medium.

As one example, as shown in FIG. 11, such recording medium may be constructed of the removable medium 81 that is separate to the main personal computer 70, has the program recorded thereon to distribute the program to the user, and is composed of a magnetic disk (including a flexible disk), an optical disc (including a CD-ROM (Compact Disc-Read Only Memory) and a DVD (Digital Versatile Disc), a magneto-optical disc (including an MD (Mini Disc)), a semiconductor memory, or the like. As an alternative example, the recording medium that distributes the program to the user may be incorporated in advance into the personal computer 70, such as by recording the program in the ROM 72 or in a hard disk drive or the like included in the storage unit 78.

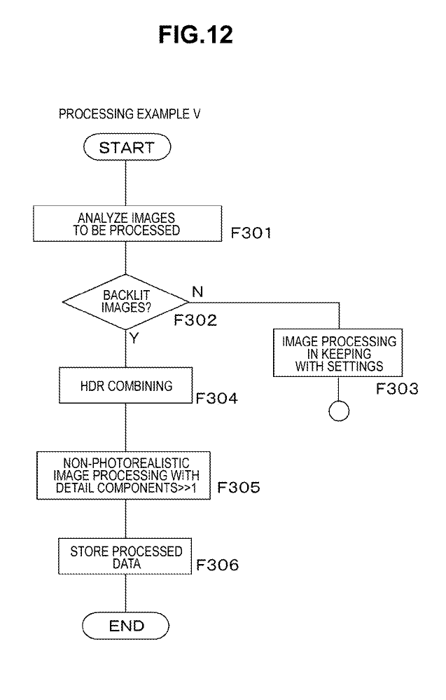

FIG. 12 shows Processing Example V executed by the CPU 71 in accordance with a program. Processing Example V in FIG. 12 is processing executed when a plurality of images (for example, the underexposed image, the appropriately exposed image, and the overexposed image described earlier) consecutively picked up by a given image pickup apparatus are processed by the personal computer 70.

For example, by loading image data of a plurality of images produced by bracketed image pickup into the personal computer 70 by transferring image data from a connected image pickup apparatus or by loading image data from the removable medium 81, it becomes possible to have processing carried out on the image data. When processing is carried out on the loaded image data, in step F301 the CPU 71 first analyzes the image data of the plurality of images to be processed. Here, it is determined whether the image data to be processed is image data that has been picked up for a backlit scene. As one example, such determination can be made using the luminance values of pixels in the image, average luminance values, weighted luminance values, luminance values in a specified region in the image, or the like.

If the scene is not backlit, the CPU 71 proceeds from step F302 to F303 and carries out image processing in keeping with an image processing program and/or user settings that are currently valid. Meanwhile, if the scene is backlit, in step S304 the CPU 71 carries out an HDR combining process. More specifically, the processing in FIG. 6A may be executed. In step F305, the CPU 71 executes non-photorealistic image processing. For example, a detail emphasizing level of a value that is sufficiently larger than “1” is set and the processing in FIG. 6B is then carried out. By doing so, painterly image processing is carried out. After this, in step F306, the CPU 71 stores the image data processed into a painterly image in the storage unit 78 or the like.

By having the CPU 71 carry out the processing shown in FIG. 12, the image data picked up for a backlit scene is processed into a painterly image and then stored. By doing so, the user is capable of automatically obtaining an artistic, non-photorealistic image for image data picked up for a backlit scene.

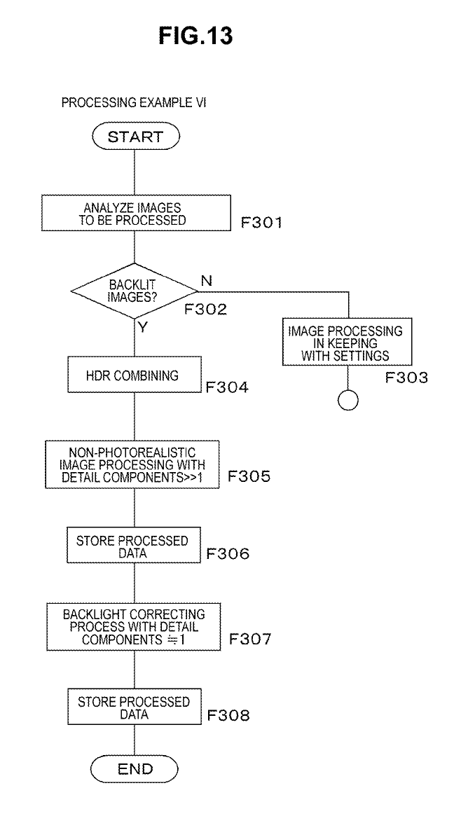

Note that it is possible for the CPU 71 to also generate image data that has been corrected for backlighting and to store backlighting-corrected image data in the storage unit 78 or the like together with the painterly image data. This is shown as Processing Example VI in FIG. 13. In FIG. 13, steps F301 to F306 are the same as in FIG. 12. In Processing Example VI, after painterly image data has been recorded in step F306, steps F307 and F308 are also executed.

In step F307, the CPU 71 carries out a backlighting correcting process. More specifically, a detail emphasizing level of a low value (for example, 1) is set and then the processing in FIG. 6B is carried out. Since the detail emphasizing level ≈1, a painterly image is not produced and instead an image produced by an HDR combining process, that is, an image corrected for backlighting is produced. In step F308, the CPU 71 then has the backlighting-corrected image data stored in the storage unit 78 or the like.

By having the CPU 71 carry out processing such as that shown in FIG. 13, image data that was picked up for a backlit scene is converted to painterly image data and backlighting-corrected image data and then stored. By doing so, the user is capable of automatically obtaining an artistic painterly image and a backlighting-corrected image for image data that was picked up for a backlit scene. Note that the process that produces the painterly image data in steps F305 and F306 and the process that produces the backlighting-corrected image data in steps F307 and F308 may be carried out in the opposite order or may be carried out in parallel.

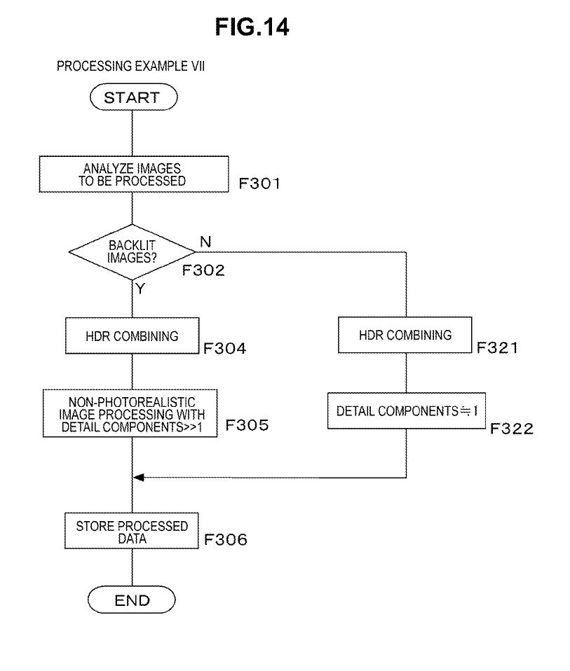

Processing Example VII is shown in FIG. 14. In FIG. 14, steps F301 to F306 are the same as in FIG. 12. Processing Example VII is an example where HDR processing is carried out even when it is determined in step F302 that the image data to be processed is not for a backlit scene. That is, if the image data is not for a backlit scene, the CPU 71 carries out an HDR combining process in step F321. More specifically, the processing in FIG. 6A is carried out. In step F322, the CPU 71 carries out the processing in FIG. 6B with a detail emphasizing level ≈1. This results in an image effect process that produces a non-photorealistic image content not being carried out on the image data relating to the HDR combining process. After this, in step F306, the CPU 71 has the processed HDR image data stored in the storage unit 78 or the like.

By having the CPU 71 carry out the processing in FIG. 14, if the image data to be processed has been picked up for a backlit scene, the image data is automatically processed to produce a painterly image and stored (F304 to F306). Meanwhile, if the image data to be processed has been picked up for a non-backlit scene, high quality HDR image data is automatically stored (F321 to F306).

Note that like Processing Example VI in FIG. 13 described earlier, when generating both painterly image data and backlighting-corrected image data for image data picked up for a backlit scene, it would be conceivable to carry out the processing in the order step F321 to step F322 and then to step F306 in FIG. 14 in place of step F303 in FIG. 13.

### 9. Program

The above embodiment has described the processing carried out by equipping the image pickup apparatus 1 or the personal computer 70 with a configuration that corresponds to the image processing apparatus according to the present disclosure. Such image processing apparatus can be constructed from hardware and/or software and the image processing apparatus and image processing method according to the present disclosure can be applied to various devices that carry out image processing. As examples aside from the image pickup apparatus and personal computer described above, an image reproducing apparatus, an image recording apparatus, a game console, a video editor, a PDA (Personal Digital Assistant), a mobile telephone or other communication apparatus, and the like can be imagined. For software in particular, by carrying out computational processing based on a program according to the present disclosure, it is possible to realize the processing described earlier in a variety of devices.

That is, a program according to an embodiment of the present disclosure causes a computational processing apparatus (such as a CPU or a DSP (Digital Signal Processor) to determine whether a plurality of image data to be processed are image data produced by image pickup of a backlit scene, to carry out an HDR combining process for the plurality of image data, and to carry out an image effect process that produces a non-photorealistic image content for the image data relating to the HDR combining process in a case where the plurality of image data to be processed are image data produced by image pickup of a backlit scene.

For example, by providing a program, which causes a computational processing apparatus to carry out the operations in the various processing blocks shown in FIGS. 5, 7, 8, 9, 12, 13, and 14, as image processing application software, it is possible to realize the image processing according to the present disclosure on a variety of devices.

Note that such program can be recorded in advance into an HDD as a recording medium that is incorporated in a device such as a personal computer, or in a ROM, a flash memory, or the like inside a microcomputer including a CPU. Alternatively, the program may be temporarily or permanently stored (recorded) on a removable recording medium such as a flexible disk, a CD-ROM (Compact Disc Read Only Memory), an MO (Magneto-Optical) disc, a DVD, a BluRay Disc, a magnetic disk, a semiconductor memory, or a memory card. Such removable recording medium can be provided as so-called “packaged software”. The program may be installed from a removable recording medium into a personal computer or the like or may be downloaded from a download site via a network such as a LAN (Local Area Network) or the Internet.

Note that the program executed by the computer may be a program in which processes are carried out in a time series in the order explained with reference to FIGS. 5, 7, 8, 9, 12, 13, and 14, a program in which the processes are carried out in parallel, or a program where processes are carried out at required timing, such as when the processes are called.

### 10. Modifications

Although an embodiment of the present disclosure has been described above, the technology of the present disclosure can be subjected to a variety of modifications. Although an example where three images with different exposure conditions, that is, the underexposed image, the appropriately exposed image, and the overexposed image are inputted into the combining processing unit 16 and HDR processing is carried out using such images is given in the examples in FIGS. 3 and 8, at least two images with different exposure conditions may be used. For example, as another conceivable example, as the data of at least two images with different exposure conditions picked up consecutively, an underexposed image and an overexposed image may be inputted into the combining processing unit 16 and the combining processing unit 16 may carry out HDR processing for such images. It is also possible to carry out HDR processing for four or more images with different exposure conditions.

The method of generating painterly image data is not limited to the method described earlier that emphasizes details. As other examples, there are also methods that change the color information of pixels by reducing the reproduced color components or by rounding off values in various color systems.

The various example configurations and processing examples described above apply a visual effect by emphasizing details in the image data that has been subjected to HDR combining, but it is also conceivably possible to apply an image effect by emphasizing details or the like before combining. For example, it is possible to emphasize details in all or part of the underexposed image, the appropriately exposed image, and the overexposed image and then carry out the HDR processing.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

An image processing apparatus including a combining processing unit carrying out an image effect process and a combining process for image data of a plurality of images, and a control unit determining whether the image data of the plurality of images is image data produced by image pickup of a backlit scene and operable, if the image data was produced by image pickup of a backlit scene, to cause the combining processing unit to carry out the image effect process that converts the image data relating to the combining process to a non-photorealistic image content.

(2)

An image processing apparatus according to (1),

wherein the control unit is operable if the image data of the plurality of images was produced by image pickup of a backlit scene, to further cause the combining processing unit to carry out the image effect process that corresponds to backlighting correction on the image data relating to the combining process.

(3)

An image processing apparatus according to (1) or (2),

wherein the combining processing unit extracts reflectance components from luminance components of the image data of one of the plurality of images or image data after the combining process and illumination components of the image data after the combining process, and carries out the image effect process on the image data after the combining process using the reflectance components, and

the control unit causes the combining processing unit to carry out the image effect process that converts to the non-photorealistic image content by setting an emphasizing level for the reflectance components.

(4)

An image processing apparatus according to (2) or (3),

wherein the combining processing unit extracts reflectance components from luminance components of the image data of one of the plurality of images or image data after the combining process and illumination components of the image data after the combining process, and carries out the image effect process on the image data after the combining process using the reflectance components, and

the control unit causes the combining processing unit to carry out the image effect process that corresponds to backlighting correction by setting an emphasizing level for the reflectance components.

(5)

An image processing apparatus according to any one of (1) to (4),

wherein the control unit is operable if the image data of the plurality of images was produced by image pickup of a non-backlit scene, to cause the combining processing unit to not carry out the image effect process that converts the image data to the non-photorealistic image content.

(6)

An image processing apparatus according to any one of (1) to (5),

wherein the image data of the plurality of images is image data of at least two images that were consecutively picked up with different exposure conditions, and

as the combining process, the combining processing unit combines the image data of the at least two images using illumination components of the image data of one of the plurality of images.

(7)

An image processing apparatus according to any one of (1) to (5),

wherein the image data of the plurality of images is image data of at least three images that were consecutively picked up with exposure conditions set respectively at overexposed, appropriately exposed, and underexposed, and

as the combining process, the combining processing unit combines the image data of the at least three images using illumination components of the image data of one of the plurality of images.

The present disclosure contains subject matter related to that disclosed in Japanese Priority Patent Application JP 2011-121843 filed in the Japan Patent Office on May 31, 2011, the entire content of which is hereby incorporated by reference.

What is claimed is:

1. An image processing apparatus comprising:
a combining processing unit carrying out an image effect process and a combining process for image data of a plurality of images; and
a control unit determining whether the image data of the plurality of images is image data produced by image pickup of a backlit scene and operable, if the image data was produced by image pickup of a backlit scene, to cause the combining processing unit to carry out the image effect process that converts the image data relating to the combining process to a non-photorealistic image content.

2. An image processing apparatus according to claim 1,
wherein the control unit is operable if the image data of the plurality of images was produced by image pickup of a backlit scene, to further cause the combining processing unit to carry out the image effect process that corresponds to backlighting correction on the image data relating to the combining process.

3. An image processing apparatus according to claim 1,
wherein the combining processing unit extracts reflectance components from luminance components of the image data of one of the plurality of images or image data after the combining process and illumination components of the image data after the combining process, and carries out the image effect process on the image data after the combining process using the reflectance components, and
the control unit causes the combining processing unit to carry out the image effect process that converts to the non-photorealistic image content by setting an emphasizing level for the reflectance components.

4. An image processing apparatus according to claim 2,
wherein the combining processing unit extracts reflectance components from luminance components of the image data of one of the plurality of images or image data after the combining process and illumination components of the image data after the combining process, and carries out the image effect process on the image data after the combining process using the reflectance components, and
the control unit causes the combining processing unit to carry out the image effect process that corresponds to backlighting correction by setting an emphasizing level for the reflectance components.

5. An image processing apparatus according to claim 1,
wherein the control unit is operable if the image data of the plurality of images was produced by image pickup of a non-backlit scene, to cause the combining processing unit to not carry out the image effect process that converts the image data to the non-photorealistic image content.

6. An image processing apparatus according to claim 1,
wherein the image data of the plurality of images is image data of at least two images that were consecutively picked up with different exposure conditions, and
as the combining process, the combining processing unit combines the image data of the at least two images using illumination components of the image data of one of the plurality of images.

7. An image processing apparatus according to claim 1,
wherein the image data of the plurality of images is image data of at least three images that were consecutively picked up with exposure conditions set respectively at overexposed, appropriately exposed, and underexposed, and
as the combining process, the combining processing unit combines the image data of the at least three images using illumination components of the image data of one of the plurality of images.

8. An image processing method comprising:
determining whether image data of a plurality of images to be processed is image data produced by image pickup of a backlit scene;
carrying out a combining process for the image data of the plurality of images; and
carrying out, if the image data was produced by image pickup of a backlit scene, an image effect process that converts the image data relating to the combining process to a non-photorealistic image content.

9. A program causing a computational processing apparatus to carry out processing comprising:
determining whether image data of a plurality of images to be processed is image data produced by image pickup of a backlit scene;
having a combining process for the image data of the plurality of images carried out; and
carrying out, if the image data was produced by image pickup of a backlit scene, an image effect process that converts the image data relating to the combining process to a non-photorealistic image content.
